(19) United States
(12) Patent Application Publication
(10) Pub. No.: US 2021/0187972 A1
(43) Pub. Date: Jun. 24, 2021

(54) MEDIUM EJECTING APPARATUS INCLUDING MEDIUM REGULATING MEMBER TO REGULATE POSITION OF FRONT END MEDIUM ON TRAY

(71) Applicant: PFU LIMITED, Kahoku-shi (JP)

(72) Inventors: Takayuki Mori, Kahoku-shi (JP); Seisuke Tsurumi, Kahoku-shi (JP)

(21) Appl. No.: 17/084,428

(22) Filed: Oct. 29, 2020

(30) Foreign Application Priority Data
Dec. 19, 2019 (JP) 2019-229578

(51) Int. Cl. B41J 11/00

(52) U.S. Cl. CPC B41J 11/0045

(57) ABSTRACT

A medium ejecting apparatus includes a housing including an ejection port to eject a medium, a tray provided below the ejection port, to load the medium ejected from the ejection port, and a medium regulating member accommodated in the housing so as to be drawn out. The medium regulating member includes a medium contacting portion capable of regulating a position of a front end of the medium on the tray in a medium ejecting direction, a first supporting portion to support the medium contacting portion, and a second supporting portion to swingably support the first supporting portion.

### CROSS-REFERENCE TO RELATED APPLICATIONS

This application is based upon and claims the benefit of priority of prior Japanese Patent Application No. 2019-229578, filed on Dec. 19, 2019, the entire contents of which are incorporated herein by reference.

### TECHNICAL FIELD

Embodiments discussed in the present specification relate to medium ejection.

### BACKGROUND

Recently, a medium ejecting apparatus such as a scanner, is required to convey, image and eject various types of media such as a business card, a receipt, a Plain Paper Copier (PPC) paper, a passport. When a plurality of media are conveyed together and ejected by the medium ejecting apparatus, the user typically aligns the front ends of the ejected media to organize the imaged media. It is desirable that positions of the media ejected from the medium ejecting apparatus are aligned so that the user can easily align the front ends of the media.

A discharge sheet loading apparatus including a document holding member having a holding portion to hold a sheet discharged to a discharge document stacking tray, a base portion located above the discharge document stacking tray, and a node portion provided between the holding portion and the base portion is disclosed (Japanese Unexamined Patent Publication (Kokai) No. 2015-229549).

An image forming apparatus including a front end pressing member to move in a direction away from a support surface by contacting with a downstream end in a discharge direction of a paper discharged to a discharge tray and apply a force by its own weight to the downstream end of the sheet is disclosed (Japanese Unexamined Patent Publication (Kokai) No. 2014-198615).

An image forming apparatus including a pressing member to press a sheet when a sheet waved in a width direction perpendicular to a sheet discharging direction and stiffened is discharged toward a discharge tray is disclosed (Japanese Unexamined Patent Publication (Kokai) No. 2019-89608).

### SUMMARY

According to some embodiments, a medium ejecting apparatus includes a housing including an ejection port to eject a medium, a tray provided below the ejection port, to load the medium ejected from the ejection port, and a medium regulating member accommodated in the housing so as to be drawn out. The medium regulating member includes a medium contacting portion capable of regulating a position of a front end of the medium on the tray in a medium ejecting direction, a first supporting portion to support the medium contacting portion, and a second supporting portion to swingably support the first supporting portion.

### BRIEF DESCRIPTION OF DRAWINGS

FIG. 1 is a perspective view illustrating a medium ejecting apparatus 100 according to an embodiment.

FIG. 2 is a perspective view illustrating the medium ejecting apparatus 100 according to an embodiment.

FIG. 3 is a schematic diagram of the medium ejecting apparatus 100 viewed from side.

FIG. 4 is a schematic diagram of the inside of the upper housing 102 viewed from side.

FIG. 5 is a diagram for illustrating a conveyance path inside the medium ejecting apparatus 100.

FIG. 6 is a schematic diagram for illustrating other medium ejecting apparatus 200.

### DESCRIPTION OF EMBODIMENTS

It is to be understood that both the foregoing general description and the following detailed description are exemplary and explanatory, and are not restrictive of the invention, as claimed.

Hereinafter, a medium ejecting apparatus according to an embodiment, will be described with reference to the drawings. However, it should be noted that the technical scope of the invention is not limited to these embodiments, and extends to the inventions described in the claims and their equivalents.

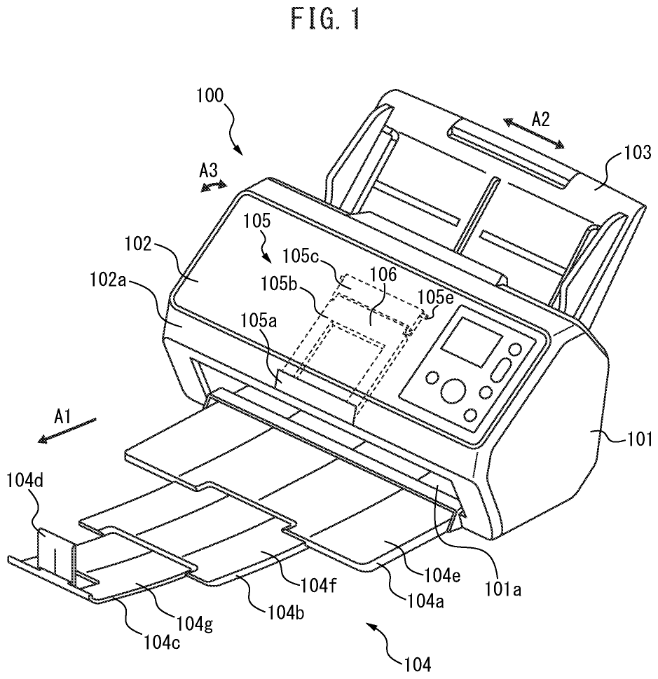

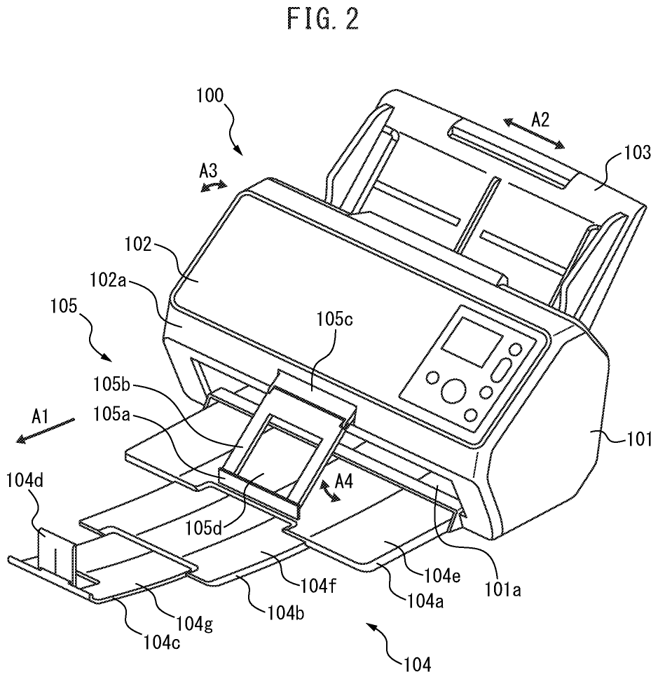

FIGS. 1 and 2 are perspective views illustrating a medium ejecting apparatus 100 configured as an image scanner. FIG. 1 shows the medium ejecting apparatus 100 in a state where a medium regulating member 105 is accommodated, FIG. 2 shows the medium ejecting apparatus 100 in a state where the medium regulating member 105 is pulled out.

The medium ejecting apparatus 100 conveys, images, and ejects a medium that is a document. A medium is paper, thick paper, a card, a booklet, a passport, etc. A paper or a thick paper includes a small-sized medium such as a business card or a receipt. The small-sized medium is, for example, a medium in which a size in a longitudinal direction is a longitudinal size of A8 (74 mm) or less. The small-sized medium may be a medium, etc., in which a size in a lateral direction is a horizontal size of A8 (52 mm) or less. A paper also includes PPC paper, such as A4 size or A3 size. The medium ejecting apparatus 100 may be a fax machine, a copying machine, a multifunctional peripheral (MFP), etc. A conveyed medium may not be a document but may be an object being printed on etc., and the medium ejecting apparatus 100 may be a printer etc. An arrow A1 in FIGS. 1 and 2 indicates a medium ejecting direction. An upstream hereinafter refers to an upstream in the medium ejecting direction A1, and a downstream refers to a downstream in the medium ejecting direction A1.

The media ejecting apparatus 100 includes a lower housing 101, an upper housing 102, a medium tray 103, an ejection tray 104 and a medium regulating member 105, etc.

The lower housing 101 and the upper housing 102 are an example of a housing. The upper housing 102 is located at a position covering the upper surface of the medium ejecting apparatus 100 and is engaged with the lower housing 101 by hinges. The upper housing 102 is provided so as to be opened and closed in a direction of an arrow A3 at a time of medium jam, during cleaning the inside of the medium ejecting apparatus 100, etc. The lower housing 101 and the upper housing 102 include an ejection port 101a to eject the medium. The upper housing 102 includes an accommodation portion 106 to accommodate the medium regulating member 105.

The medium tray 103 is engaged with the lower housing 101 in such away as to be able to place a medium to be conveyed.

The ejection tray 104 is an example of a tray, and is provided below the ejection port 101a, and engages with the lower housing 101 so as to load the medium ejected from the ejection port 101a. The ejection tray 104 includes a first tray 104a, a second tray 104b, a third tray 104c and a stopper 104d.

The first tray 104a is accommodated inside the lower housing 101 when the medium ejecting apparatus 100 is not used. The first tray 104a is pulled out from the lower housing 101 in the medium ejecting direction A1, and loads the medium ejected from the ejection port 101a when the medium ejecting apparatus 100 is used. The second tray 104b is provided so as to be pulled out from the first tray 104a in the medium ejecting direction A1 so that a medium having a large size is placed on the ejection tray 104. The third tray 104c is provided so as to be able to be pulled out from the second tray 104b in the medium ejecting direction A1 so that the medium having a larger size is placed on the ejection tray 104. The first tray 104a, the second tray 104b and the third tray 104c have a first placing surface 104e, a second placing surface 104f and a third placing surface 104g on which the ejected medium is placed, respectively.

The stopper 104d is foldably provided at the downstream end of the third tray 104c. The stopper 104d stops the front end of the medium of the maximum size supported by the medium ejecting apparatus 100, for example, A4 size or A3 size, ejected to the ejection tray 104, by being raised, and aligns the front end of each medium. On the other hand, the first tray 104a, the second tray 104b and the third tray 104c can be accommodated in the lower housing 101 when the stopper 104d is folded.

The ejection tray 104 may be fixed to the lower housing 101 so as not to be drawn and accommodated. The second tray 104b and/or the third tray 104c may be omitted. When the third tray 104c is omitted, the stopper 104d is provided on the second tray 104b. When the second tray 104b and the third tray 104c are omitted, the stopper 104d is provided on the first tray 104a.

The medium regulating member 105 is a stopper for a small-sized medium, regulates the front end (downstream end) position of the medium on the ejection tray 104 in the medium ejecting direction A1. The medium regulating member 105 is accommodated in the upper housing 102 so as to be drawn out. As shown in FIG. 1, the medium regulating member 105 is accommodated in the accommodation portion 106 provided in the upper housing 102, when the medium ejecting apparatus 100 is not used, or when the small-sized medium is not conveyed and ejected. On the other hand, as shown in FIG. 2, the medium regulating member 105 is drawn out by the user and is used, when the medium ejecting apparatus 100 is used, and when the small-sized medium is conveyed and ejected.

The medium regulating member 105 includes a medium contacting portion 105a, a first supporting portion 105b, and a second supporting portion 105c. The medium contacting portion 105a, the first supporting portion 105b and the second supporting portion 105c are formed of a resin material or a metal material, etc., respectively. The medium contacting portion 105a and the first supporting portion 105b are formed of an integral member. A pair of the medium contacting portion 105a and the first supporting portion 105b, and the second supporting portion 105c are formed of separate members. The medium contacting portion 105a, the first supporting portion 105b and the second supporting portion 105c may be formed of an integral member. The medium contacting portion 105a, the first supporting portion 105b and the second supporting portion 105c may be formed of separate members.

The medium contacting portion 105a is capable of regulating a position of the front end of the medium on the ejection tray 104 in the medium ejecting direction A1. The medium contacting portion 105a is linearly formed along the width direction A2 perpendicular to the medium ejecting direction so as to be in contact with the front end of the medium ejected to the ejection tray 104 over both ends of the medium contacting portion 105a. Thus, the medium contacting portion 105a can stop the small-sized medium so that the front ends of the ejected small-sized media are linearly aligned.

Further, as shown in FIG. 1, the medium contacting portion 105a and the front surface 102a of the upper housing 102 are arranged so as to be flush with each other in a state where the medium regulating member 105 is accommodated in the upper housing 102. Thus, the medium ejecting apparatus 100 has a design with a sense of unity in a state where the medium regulating member 105 is accommodated.

The first supporting portion 105b supports the medium contacting portion 105a. The first supporting portion 105b is provided with an opening 105d at the center thereof. The opening 105d is provided so as to adjust a load applied from the medium contacting portion 105a to the ejection tray 104. In other words, a position of a center of gravity of the medium regulating member 105 is positioned on the downstream side, and the load applied from the medium contacting portion 105a to the ejection tray 104 is increased, as the opening 105d is provided on the upstream side in the medium ejecting direction A1. On the other hand, the position of the center of gravity of the medium regulating member 105 is positioned on the upstream side, and the load applied from the medium contacting portion 105a to the ejection tray 104 is reduced, as the opening 105d is provided on the downstream side in the medium ejecting direction A1. Further, the smaller the opening 105d is, the larger a weight of the entire medium regulating member 105 is, and the larger the load applied from the medium contacting portion 105a to the ejection tray 104 is. On the other hand, the larger the opening 105d is, the smaller the weight of the entire medium regulating member 105 is, and the smaller the load applied from the medium contacting portion 105a to the ejection tray 104 is.

The media regulating member 105 is used to stop the front end of the small-sized medium when the small-sized medium is ejected to the ejection tray 104. Therefore, it is desirable that the load applied from the medium contacting portion 105a to the ejection tray 104 is set to a magnitude such that the medium contacting portion 105a does not float up by a force by the small-sized medium ejected by an ejection roller (described later)(and away from the ejection roller) advancing in the medium ejecting direction A1. On the other hand, when the medium of a size larger than the small-sized medium is ejected to the ejection tray 104, the medium regulating member 105 needs to pass the medium without stopping so that the medium does not deflect. Therefore, it is desirable that the load applied from the medium contacting portion 105a to the ejection tray 104 is set to a magnitude such that the medium contacting portion 105a floats by a force by the medium ejected by the ejection roller (and in contact with the ejection roller) advancing in the medium ejecting direction A1. By the opening 105d provided in the first supporting portion 105b, the medium ejecting apparatus 100 can suitably adjust the load applied from the medium contacting portion 105a to the ejection tray 104 while maintaining the strength of the medium regulating member 105.

In particular, it is preferable that the opening 105d is provided so that the position of the center of gravity of the medium regulating member 105 is positioned on the upstream side of the center position in the medium ejecting direction A1. Thus, the medium regulating member 105 can suitably stop the front end of the small-sized medium without disturbing an ejection of a medium larger than the small-sized medium.

Further, by the opening 105d provided in the first supporting portion 105b, the user can confirm a state in which the medium is ejected from the opening 105d, and the medium ejecting apparatus 100 can improve a convenience of the user.

The second supporting portion 105c swingably (rotatably) supports the first supporting portion 105b. In particular, the second supporting portion 105c swingably supports the first supporting portion 105b in a vertical direction A4 which is a direction substantially perpendicular to the first placing surface 104e of the first tray 104a. Thus, the medium regulating member 105 is located along the accommodation portion 106 to be compactly accommodated when accommodated in the upper housing 102, the medium regulating member 105 can contact the medium contacting portion 105a to the ejection tray 104 when drawn out from the upper housing 102.

The first supporting portion 105b is swingably provided upward with respect to the second supporting portion 105c when the upper housing 102 is opened in a state where the medium regulating member 105 is pulled out from the upper housing 102. Thus, when the user accidentally opens the upper housing 102 in a state where the medium regulating member 105 is pulled out from the upper housing 102, it is suppressed that the medium regulating member 105 is sandwiched between the upper housing 102 and the ejection tray 104 to be damaged.

As shown in FIG. 1, the second supporting portion 105c has a protrusion 105e. The second supporting portion 105c is locked in the upper housing 102 by the protrusion 105e abutting on an inside of the front surface 102a of the upper housing 102 in a state where the medium regulating member 105 is pulled out from the upper housing 102.

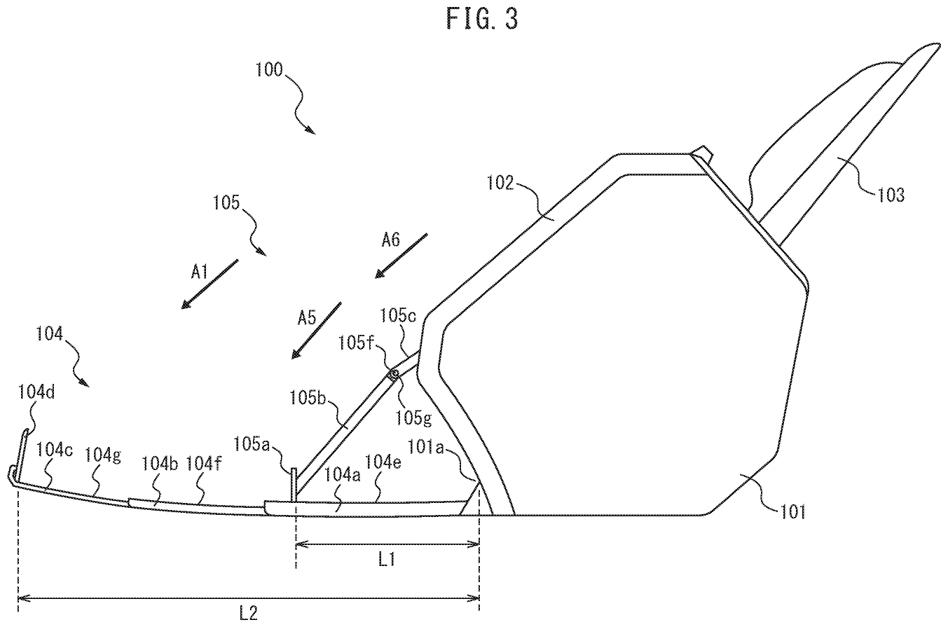

FIG. 3 is a schematic diagram of the medium ejecting apparatus 100 in a state where the medium regulating member 105 is pulled out from the upper housing 102 viewed from side.

As shown in FIG. 3, the first supporting portion 105b and the second supporting portion 105c have a protrusion 105f and a recess 105g, respectively. The second supporting portion 105c engages the protrusion 105f with the recess 105g to swingably support the first supporting portion 105b with the recess 105g as a swing axis. An extending direction A5 of the first supporting portion 105b drawn out from the upper housing 102 and supported by the second supporting portion 105c is different from a direction A6 in which the first supporting portion 105b is drawn out from the upper housing 102. Thus, the medium regulating member 105 is drawn out from the upper housing 102 along the housing portion 106, and can contact the medium contacting portion 105a at an appropriate position of the ejection tray 104 after being drawn out from the upper housing 102.

The medium contacting portion 105a is provided so as to be in contact with the first placing surface 104e of the first tray 104a and so as not to be in contact with the second placing surface 104f of the second tray 104b, in a state where the medium regulating member 105 is pulled out from the upper housing 102. Thus, the medium contacting portion 105a is not dragged by the second placing surface 104f even when the second tray 104b is accommodated in the first tray 104a while the medium regulating member 105 is pulled out from the upper housing 102, thereby, it is suppressed that the medium regulating member 105 is damaged.

As described above, the medium regulating member 105 is used for stopping the front end of the small-sized medium when the small-sized medium is ejected to the ejection tray 104. Therefore, a distance L1 from the ejection port 101a to the medium contacting portion 105a is set to be less than the maximum size of the medium supported by the medium ejecting apparatus 100 and equal to or larger than the size of the small-sized medium. The maximum size of the medium supported by the medium ejecting apparatus 100 is, for example, a longitudinal size (297 mm) of A4 or a longitudinal size (420 mm) of A3, etc. The size of the small-sized medium is, for example, a longitudinal size of A8 (74 mm) or a lateral size of A8 (52 mm). Thus, the medium contacting portion 105a can stop the front end of the small-sized medium when the small-sized medium is ejected to the ejection tray 104.

On the other hand, a distance L2 from the ejection port 101a to the stopper 104d is set to be substantially the same as the maximum size of the medium supported by the medium ejecting apparatus 100. Thus, the stopper 104d can stop the front end of the medium when the medium of the maximum size supported by the medium ejecting apparatus 100 is ejected to the ejection tray 104.

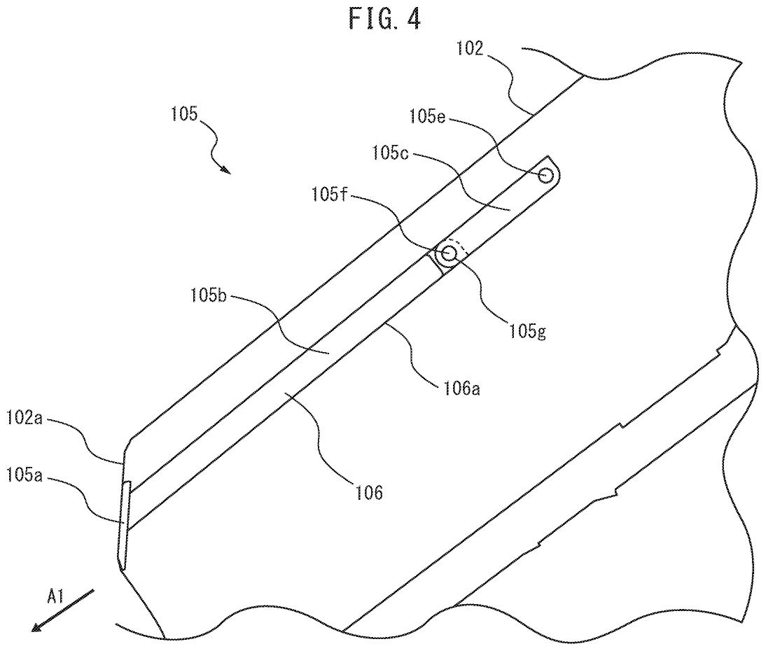

FIG. 4 is a schematic diagram of the inside of the upper housing 102 in a state where the medium regulating member 105 is accommodated in the upper housing 102 vied from side.

As shown in FIG. 4, the accommodation portion 106 includes a guide member 106a formed by a rail linearly formed. The first supporting portion 105b and the second supporting portion 105c are linearly arranged along the guide member 106a when accommodated in the accommodation portion 106, and slide along the guide member 106a when pulled out from the accommodation portion 106. Thus, the medium ejecting apparatus 100 can sufficiently reduce the space in the height direction of the housing portion 106, and can reduce the device size.

As described above, the medium contacting portion 105a is linearly formed over both ends, and the front surface of the medium contacting portion 105a and the front surface 102a of the upper housing 102 are arranged so as to be flush with each other in a state where the medium regulating member 105 is accommodated in the upper housing 102. Thus, the medium ejecting apparatus 100 has a design with a sense of unity in a state where the medium regulating member 105 is accommodated.

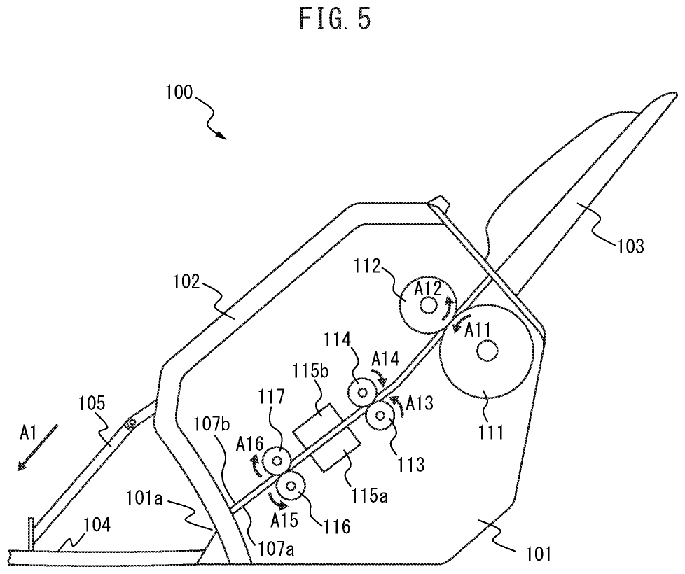

FIG. 5 is a diagram for illustrating a conveyance path inside the medium ejecting apparatus 100.

The conveyance path inside the medium ejecting apparatus 100 includes a feed roller 111, a brake roller 112, a first conveyance roller 113, a second conveyance roller 114, a first imaging device 115a, a second imaging device 115b, a first ejection roller 116 and a second ejection roller 117, etc. The numbers of each roller is not limited to one, and may be plural. A top surface of the lower housing 101 forms a lower guide 107a of a conveyance path of a medium, and a bottom surface of the upper housing 102 forms an upper guide 107b of the conveyance path of a medium.

The first imaging device 115a includes a line sensor based on a unity-magnification optical system type contact image sensor (CIS) including an imaging element based on a complementary metal oxide semiconductor (CMOS) linearly located in a main scanning direction. Further, the first imaging device 115a includes a lens for forming an image on the imaging element, and an A/D converter for amplifying and analog-digital (A/D) converting an electric signal output from the imaging element. The first imaging device 115a generates and outputs an input image imaging a front side of a conveyed medium, in accordance with control from a processing circuit to be described later.

Similarly, the second imaging device 115b includes a line sensor based on a unity-magnification optical system type CIS including an imaging element based on a CMOS linearly located in a main scanning direction. Further, the second imaging device 115b includes a lens for forming an image on the imaging element, and an A/D converter for amplifying and A/D converting an electric signal output from the imaging element. The secondary imaging device 115b generates and outputs an input image acquired by imaging a back surface of the conveyed medium, in accordance with control from a processing circuit to be described later.

Only either of the first imaging device 115a and the second imaging device 115b may be located in the medium ejecting apparatus 100 and only one surface of a medium may be read.

Further, a line sensor based on a unity-magnification optical system type CIS including an imaging element based on charge coupled devices (CCDs) may be used in place of the line sensor based on a unity-magnification optical system type CIS including an imaging element based on a CMOS. Further, a line sensor based on a reduction optical system type line sensor including an imaging element based on CMOS or CCDs.

A medium placed on the medium tray 103 is conveyed between the lower guide 107a and the upper guide 107b in the medium ejecting direction A1 by the feed roller 111 rotating in a direction of an arrow A11 in FIG. 5. When the medium is conveyed, the brake roller 112 rotates in a direction of an arrow A12. By the workings of the feed roller 111 and the brake roller 112, when a plurality of media are placed on the medium tray 103, only a medium in contact with the feed roller 111, out of the media placed on the medium tray 103, is separated. Consequently, the medium conveying apparatus 100 operates in such a way that conveyance of a medium other than the separated medium is restricted (prevention of multi-feed).

The medium is fed between the first conveyance roller 113 and the second conveyance roller 114 while being guided by the lower guide 107a and the upper guide 107b. The medium is fed between the first imaging device 115a and the second imaging device 115b by the first conveyance roller 113 and the second conveyance roller 114 rotating in directions of an arrow A13 and an arrow A14, respectively. The medium read by the first imaging device 115a and the second imaging device 115b is ejected onto the ejection tray 104 by the first discharge roller 116 and the second discharge roller 117 rotating in directions of an arrow A15 and an arrow A16, respectively.

As described above in detail, in the medium ejecting apparatus 100, the medium regulating member 105 to regulate the position of the front end of the small-sized medium ejected onto the ejection tray 104 is provided, and the accommodation portion 106 to accommodate the medium regulating member 105 is provided. Thus, the medium ejecting apparatus 100 can reduce the device size when not in use, while suitably aligning the front ends of the ejected media.

In particular, since the medium ejecting apparatus 100 stops the small-sized medium by the medium regulating member 105, it is suppressed that the small-sized medium that has been previously ejected is extruded by the small-sized medium ejected later. Further, it is suppressed that the later ejected small-sized medium slips under the extruded small-sized medium and an order of the media is changed, as a result of the previously ejected small-sized medium being extruded. Further, by the medium regulating member 105, the ejected small-sized medium is prevented from popping out from the ejection tray 104. Thus, the user can easily align the plurality of ejected media, thereby, the medium ejecting apparatus 100 can improve the convenience of the user and reduce the total time required for the medium reading processing.

Further, since the medium regulating member 105 can be accommodated in the upper housing 102 when not in use, the medium ejecting apparatus 100 can reduce a possibility that the medium regulating member 105 is lost when not in use. Further, since the user can accommodate the medium regulating member 105 when opening and closing the upper housing 102, the medium ejecting apparatus 100 can suppress that the opening and closing of the upper housing 102 is prevented by the medium regulating member 105.

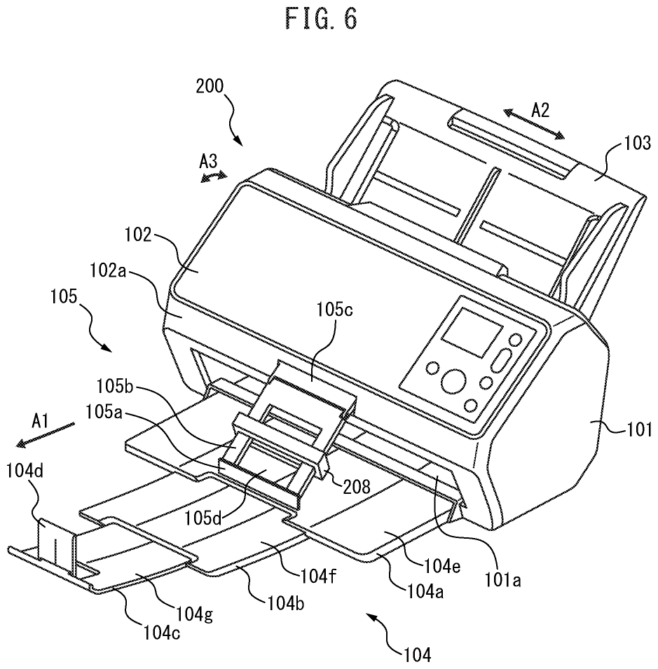

FIG. 6 is a schematic diagram for illustrating a medium ejecting apparatus 200 according to another embodiment. The medium ejecting apparatus 200 further includes a load member 208 in addition to the respective portions of the medium ejecting apparatus 100.

The load member 208 is a detachable weight to the first supporting portion 105b. An attaching position of the load member 208 to the first supporting portion 105b in the medium ejecting direction A1 is changeably provided from the downstream end to the upstream end. As described above, the medium regulating member 105 needs to pass the medium larger size than the small-sized medium without stopping, while stopping the small-sized medium. The user can change the attaching position of the load member 208 according to the type of the conveyed medium, and the medium ejecting apparatus 100 can more suitably adjust the load applied from the medium contacting portion 105a to the ejection tray 104. The shape of the load member 208 is not limited to the shape shown in FIG. 6, the load member 208 may have any shape.

As described in detail above, the medium ejecting apparatus 200 can reduce the device size when not in use, while suitably aligning the front ends of the ejected media, even when using the load member 208.

According to the embodiment, the medium ejecting apparatus can reduce the device size when not in use, while suitably aligning the front ends of the ejected media.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A medium ejecting apparatus comprising:
a housing including an ejection port to eject a medium;
a tray provided below the ejection port, to load the medium ejected from the ejection port; and
a medium regulating member accommodated in the housing so as to be drawn out, wherein
the medium regulating member includes
a medium contacting portion capable of regulating a position of a front end of the medium on the tray in a medium ejecting direction,
a first supporting portion to support the medium contacting portion, and
a second supporting portion to swingably support the first supporting portion.

2. The medium ejecting apparatus according to claim 1, wherein the medium contacting portion is linearly formed along a direction perpendicular to the medium ejecting direction.

3. The medium ejecting apparatus according to claim 1, wherein a distance from the ejection port to the medium contacting portion is less than a maximum size of a medium supported by the medium ejecting apparatus and equal to or larger than a size of a small-sized medium.

4. The medium ejecting apparatus according to claim 1, wherein the first supporting portion includes an opening provided so as to adjust a load applied from the medium contacting portion to the tray.

5. The medium ejecting apparatus according to claim 1, further comprising a load member detachable to the first supporting portion, and capable of changing an attaching position to the first supporting portion in the medium ejecting direction.

6. The medium ejecting apparatus according to claim 1, wherein
the housing is provided so as to be opened and closed, and
the first supporting portion is swingably provided upward with respect to the second supporting portion when the housing is opened in a state where the medium regulating member is pulled out from the housing.

7. The medium ejecting apparatus according to claim 1, wherein
the tray includes a first tray and a second tray provided so as to be pulled out from the first tray, and
the medium contacting portion is provided so as to be in contact with the first tray and so as not to be in contact with the second tray, in a state where the medium regulating member is pulled out from the housing.

8. The medium ejecting apparatus according to claim 1, wherein the extending direction of the first supporting portion drawn out from the housing and supported by the second supporting portion is different from a direction in which the first supporting portion is drawn out from the housing.

9. The medium ejecting apparatus according to claim 1, wherein the second supporting portion swingably supports the first supporting portion in a vertical direction.
